(19) United States
(12) Patent Application Publication
(10) Pub. No.: US 2018/0129947 A1
(43) Pub. Date: May 10, 2018

(54) METHOD AND SYSTEM FOR PREDICTING THE REALIZATION OF A PREDETERMINED STATE OF AN OBJECT

(71) Applicant: TELLMEPLUS, Saint-Clément-de-Rivière (FR)

(72) Inventors: Jean-Michel CAMBOT, Castelnau-le-Lez (FR); Rémi COLETTA, Gignac (FR); Loic LINAIS, Gignac (FR); Emmanuel CASTANIER, Jacou (FR)

(21) Appl. No.: 15/574,255

(22) PCT Filed: May 18, 2016
(86) PCT No.: PCT/EP2016/061138

§ 371 Date: Nov. 15, 2017

(30) Foreign Application Priority Data
May 19, 2015 (FR) 1554441

(51) Int. Cl. G06N 5/04; G06N 99/00

(52) U.S. Cl. CPC G06N 5/04; G06N 99/005

(57) ABSTRACT

A method is provided for predicting the future realization of at least one state that can be adopted by an object, based on a source database, storing for the past occurrences of the at least one state, values for the variables relating to the object, the method including the following steps:
generating at least two classifiers according to two different data classification algorithms,
for each of the classifiers, machine learning, and
selecting the best classifier from the classifiers;
   the method also including a phase, called detection phase, including:
updating the source database over time, and
at least one prediction step by the best classifier, based on the updated source database.

The present invention relates to a method for predicting the realization of a state of an object, before said state is realized. It also relates to a system implementing such a method.

The field of the invention is the field of predicting the occurrence of a predetermined event relating to an object, and in particular a breakdown of an appliance or an element of an appliance before said breakdown takes place.

### PRIOR ART

Regardless of their level of development, industrial machines are regularly subject to breakdowns. When deployed in their operating environment, the first consequence of breakdowns of these machines is a reduction or interruption in the functionality that they provide, regardless of the field in question.

Methods and systems currently exist making it possible to detect a breakdown of a machine, and more generally a state of an object when said state occurs. These methods and systems are based on one or more sensors arranged on the target machine and provided in order to detect the breakdown of the machine after the realization of said breakdown has taken place.

These methods have several drawbacks. On the one hand, these methods do not make it possible to avoid a reduction or an interruption in the functionality carried out by the machine. On the other hand, as the detection of the breakdown does not take place until after its realization, the resolution of the breakdown cannot be carried out rapidly, which leads to a reduction/absence of functionality during a significant period.

In order to try to overcome these drawbacks, methods and systems for predicting breakdown have been developed. These methods implement an algorithm for predicting a breakdown of a target machine taking account of diverse data relating to said target machine. However, these methods and systems also have drawbacks: they are developed specifically for one type of machine, are not very flexible, and provide results that are not very accurate.

An aim of the present invention is to overcome the aforesaid drawbacks.

Another aim of the present invention is to propose a more flexible method and system for predicting a state of an object.

It is also an aim of the present invention to propose a method and system for predicting a state of an object, capable of being used for all types of objects, with few modifications.

Finally, another aim of the present invention is to propose a method and system for predicting a state of an object, providing more accurate results.

### SUMMARY OF THE INVENTION

At least one of these aims is achieved by a method for predicting the realization of at least one state that can be adopted by an object, before said state is realized, based on a database, called source database, storing for a least one, in particular several past occurrence(s) of said at least one state, values for at least one, in particular several, variable(s) relating to said object, determined before said, or each one of said, occurrence(s) of said state, said method comprising the following steps:
generating at least two classifiers according to two different data classification algorithms,
for each of said classifiers, machine learning on a first part of said source database,
selecting, from said classifiers, one classifier, called best classifier, providing the best prediction performance on a second part of said source database, by comparing the results supplied by each classifier;
   said method also comprising a phase, called detection phase, comprising:
updating said source database over time, with at least one new value for said variable,
at least one step of predicting a state, by said best classifier, based on said updated source database.

Thus, in order to detect the future realization of a state of an object, the prediction method according to the invention makes it possible to generate and to test several prediction classifiers based on data relating to said object, and in particular on the past occurrences of said state, and to choose the classifier supplying the best prediction result.

As a result, the method according to the invention is more flexible, as it makes it possible to adapt to any type of object for the detection of any state the past occurrences of which are known, by proposing training each classifier directly as a function of the data relating to the object.

The method according to the invention can also be used for all types of objects, with few modifications, as it makes it possible to select, in an automated manner, the most suitable classifier for each object from several classifiers using different algorithms.

Finally, the method according to the invention makes it possible to produce a more accurate prediction of the realization of a state of an object, as the prediction is produced with the classifier which, from several classifiers tested, supplies the best prediction result.

Of course, each of the first and second parts of the source database comprises at least one past occurrence, in particular multiple past occurrences, for the at least one state of the object.

By “classifier” is meant an algorithm or family of statistical classification algorithms. This concept is well known per se to a person skilled in the art in the field of statistical classification. It is therefore not necessary to give further details of this concept.

By “training” is meant the procedure making it possible to determine, in particular by iteration, the coefficients of a classifier as a function of known input data and known output data. This concept is also well known per se to a person skilled in the art in the field of statistical classification. It is therefore not necessary to give further details of this concept. Further details about training may be found on the page at the following address: https://en.wikipedia.org/wiki/Machine_learning

In the description hereinafter, the object for which the prediction is made may be called target object in order to avoid overloading the description.

Advantageously, the method according to the invention can also comprise at least one iteration of a step, called verification step, for verifying over time that the best classifier remains that which, from all the classifiers generated, supplies the best prediction performance, said verification step comprising the training and selection steps carried out on said updated database at the time of said iteration of said verification step.

This verification step is carried out after one or more prediction steps.

Thus, the method according to the invention makes it possible to monitor over time that the classifier chosen at the start of the method remains the one which supplies the best prediction result.

This feature of the method according to the invention is particularly advantageous. In fact, thanks to this feature, the prediction method according to the invention is not based on training a classifier learned once and for all, but continues to learn progressively. This functionality makes it possible to take account of change over time of the target object, such as for example ageing of the target object, modification of the usage of the target object, etc.

The verification step can be triggered by an operator and/or in an automated manner with a predetermined frequency, for example as a function of the iteration number of the detection phase.

According to a non-limitative embodiment, the step of selecting the best classifier can comprise:
measuring, for each classifier:
   a data, called accuracy data, relating to an error rate during the detection of the past occurrences of at least one state;
   a data, called recall data, relating to the number of past occurrences of at least one state, detected by said classifier;
selecting the best classifier as a function of said accuracy data and/or said recall data.

Thus, the method according to the invention makes it possible to better take account of the results of each classifier with a view to choosing the classifier supplying the best prediction result.

Advantageously, the method according to the invention can also comprise, after the step of machine learning, a step, called cross-validation step, testing at least one, in particular each, classifier, on a third part of said source database.

Of course, this third part of the source database comprises at least one past occurrence, in particular multiple past occurrences for the at least one state of the object.

This step of cross-validation makes it possible to validate the training of a classifier carried out on the first part of the source database, on a third part, different from the first part. This step of cross-validation makes it possible more particularly to test the stability of each classifier obtained following the training step.

There are various cross-validation techniques that can be used for a classifier, such as for example the technique known as “testset validation”, the technique known as “holdout method”, the technique known as “k-fold cross-validation” or also the technique known as “leave-one-out cross-validation”.

The first part of the source database, used for the training, can be called the training part. It can correspond to 60% or more of the source database.

The second part of the database, different from the first part, can be called the selection part. The second part of the database can correspond to 20% of the source database.

The third part of the database, different from the first and the second part, can be called the test, or cross-validation part. The third part of the database can correspond to 20% of the source database.

The first part and the third part of the source database can be different for each classifier. In contrast, the second part of the source database, used during the selection step, is identical for each classifier.

The generating step can advantageously comprise, for at least one classifier, a step of setting/input of a parameter relating to the architecture of said classifier.

Such a parameter can be or comprise a maximum/minimum number of nodes in the classifier, a maximum/minimum depth of said classifier, a tree number in the classifier, etc.

Such a setting step makes it possible to apply at least one constraint, identical or different, for at least one, in particular each, classifier and thus to control/set the computer resources necessary for the execution of the method according to the invention, for example in terms of memory and calculation power, and/or execution time of the method according to the invention. It is thus possible to further set and customize the method according to the invention at each object, and more generally in each case.

Advantageously, the method according to the invention can comprise, before the training step, a step of generating said source database by reconciliation of at least one database comprising values of at least one variable relating to said object, with at least one other database comprising data relating to at least one past occurrence of at least one state.

Such a step is necessary when the data relating to the target object are stored in different databases. For example, in the case of machines of the elevator type, it is very often the case that the data measured by the sensors arranged on the elevator are stored in a first database, and the data relating to past breakdowns of the elevator are stored in another database. In this case, it is necessary to construct a single database comprising both the data measured by the sensors and the past occurrences of a breakdown of the elevator.

According to a particularly preferred embodiment, for the target object, in particular for each target object, the data relating to said object are organized in the form of a chronological timeline.

More particularly, the source database comprises for the target object, in particular for each target object, a timeline on which are shown chronologically:
the values of the measured variables, and
the signalling of the occurrence of a state, in particular of each state, of the object, etc.
for each state, data relating to an intervention, such as a repair or a replacement of the object or an element of the object.

More generally, for each target object, the source database can advantageously store:
for each measured value of a variable, at least one time data relating to the time said value was measured, and
for each past occurrence of at least one, in particular each, state, a time data relating to the time of said occurrence.

According to an advantageous embodiment, at least one, in particular each, of the steps, in particular the training step, and/or the selection step, and/or the prediction step, can take account of the data on a predetermined sliding time window preceding the current time.

Thus, the method according to the invention makes it possible to carry out a prediction based not on an instantaneous snapshot of the values of the variables relating to the object, but on a change in the values of these variables. Such a prediction is more accurate and more refined.

For example, a high instantaneous temperature value measured by a sensor of a machine is not necessarily a sign of a breakdown in the machine; the way in which the temperature has changed must be taken into account. In fact, although it is possible that a regular temperature increase is not a sign of breakdown, a rapid peak in temperature may be. The method according to the invention makes it possible to carry out a fine prediction allowing these cases to be distinguished. This makes it possible either to avoid false alarms, or to avoid failure to detect a future breakdown.

For at least one target object, the source database can also comprise:
at least one data calculated as a function of one or more measured data and from a predetermined relationship, such as for example an addition, a subtraction, an average, a variance, an integral or a derivative of one or more variables, for example over a predetermined time window,
at least one data, called exogenous, relating to an environment in which said target object is located, such as for example a temperature external to said object, humidity external to said object, a breakdown of an element or an appliance with which said object is associated or with which said object cooperates, etc.

At least one classifier used in the present invention can be implemented:
a decision tree,
a support vector machine,
a clustering algorithm, i.e. a hierarchical or partitioning grouping algorithm,
a neural network,
a linear regression,
a set of decision trees, of the “random forest” type for example,
etc.

Each of these classifiers is known per se by a person skilled in the art in the field of prediction. It is therefore not necessary here to give further details of the architecture of each of these classifiers.

For at least one classifier, the machine learning step can be carried out by a training that is:
supervised,
not supervised,
semi-supervised,
partially supervised,
by reinforcement, or
by transfer.

Each of these training techniques is also known per se to a person skilled in the art. For reasons of brevity, they will therefore not be detailed in the present application.

The prediction step can comprise a supply of at least one data relating to the result of the prediction, in particular regardless of the result of the prediction or only when the result of the prediction gives evidence of the future realization of a predetermined state.

This step can also comprise displaying at least one data when a future realization of a state is detected. Alternatively or in addition, this prediction step can comprise displaying a data identifying the detected state, for example in the form of a message that can be understood by humans.

Furthermore, the prediction step can in addition or alternatively, trigger an audible or visual warning when a predetermined state, for example a breakdown, is detected.

The method according to the invention can be implemented for predicting a state among several predetermined states for an object.

The method according to the invention can also be implemented for predicting a state for several objects, identical or different, arranged on one and the same site or on at least two sites distributed in space, i.e. remote from one another.

In this case, the method can be carried out for each object, independently of the others.

Alternatively or in addition, for at least one object, the method can take account of at least one data relating to another object or an element of another object located on the same site.

For example, when the method is used for predicting a breakdown for elevators, it can be applied independently for each elevator, in particular when they are all remote from one another. In contrast, in the case where two elevators are located on one and the same site, in particular in one and the same building, the method can take account of at least one data relating to one of the elevators for predicting a breakdown of the other elevator and vice versa.

Advantageously, the method according to the invention can be applied for predicting a breakdown of a machine or of an element of a machine.

In this case, the measured variables relating to the machine can comprise at least one of the following variables: pressure, temperature, humidity, etc. in/around the machine, in/around an element of the machine, etc. More generally, the method according to the invention can be applied to any machine equipped with sensor(s) and capable of regularly uploading data relating to the machine or an element of the machine (in particular, the connected objects).

The invention also relates to a computer program product comprising instructions implementing all the steps of the method according to the invention, when it is implemented or loaded into a computer device.

Such a computer program product can comprise computer instructions written in all types of computer languages, such as C, C++, Java, etc.

The invention also relates to a system comprising means configured for implementing all the steps of the method according to the invention.

Such a system can amount to a computer, or more generally an electronic/computer device.

### DESCRIPTION OF THE FIGURES AND EMBODIMENTS

Other advantages and characteristics will become apparent on examination of the detailed description of examples which are in no way limitative, and the attached drawings, in which:

FIG. 1 is a diagrammatic representation of a non-limitative embodiment of a prediction method according to the invention,

FIG. 2 is a diagrammatic representation of a non-limitative embodiment of a system according to the invention, in particular for implementing the method in FIG. 1, and

FIGS. 3-4 give a diagrammatic representation of a highly simplified embodiment for predicting the operational state of four machines.

It is well understood that the embodiments that will be described hereinafter are in no way limitative. In particular, variants of the invention can be considered comprising only a selection of characteristics described hereinafter in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together if there is no objection to this combination from a technical point of view.

In the figures, elements common to several figures retain the same reference.

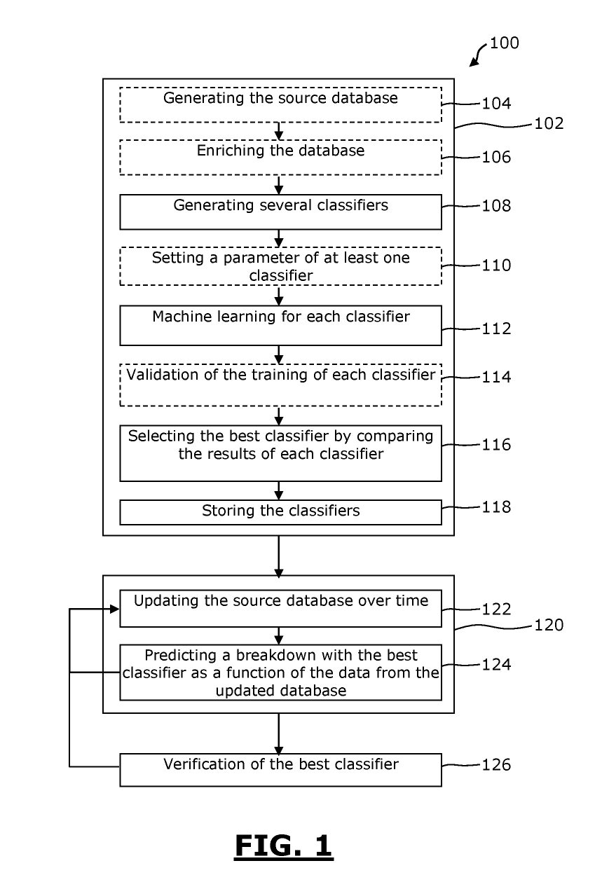

FIG. 1 is a diagrammatic representation of a non-limitative embodiment of a prediction method according to the invention.

The method 100 described in FIG. 1 will be described hereinafter within the framework of an example application which is the detection of breakdowns on elevators arranged on sites that are distributed in space.

The method 100 shown in FIG. 1 comprises a phase 102, called prior phase, carried out only at the start of the method 100.

This prior phase 102 comprises an optional step 104 of generating a source database, presented in the form of a timeline, for each elevator involved in the prediction. The source database can be generated by measurement and detection of data, over a predetermined period, by sensors arranged on each elevator.

Alternatively, the source database can be generated by reconciliation of data previously stored in several databases, namely:
at least one database comprising the values of different variables measured for each elevator over time, as well as for each measurement, timestamping data indicating the time of the measurement, and
at least one database listing the past breakdowns for each elevator, as well as timestamping data indicating the time of the breakdown.

The variables the values of which are measured for each elevator can comprise the temperature, the pressure, the load carried by the elevator, the number of outward-return movements carried out, distance covered, etc.

Of course, if the source database exists, step 104 is not carried out.

The method 100 also comprises an optional step 106 of enriching the source database by one or more variables obtained by processing the variables that already exist in the database. For example, this step 106 can add to the database at least one variable obtained by application of a mathematical relationship to at least one variable existing in the database, such as for example:
an addition, a subtraction, a multiplication and/or a division, of at least two variables or at least two values of one and the same variable,
a variance, a derivative, an integral of at least one variable over a predetermined time window, in particular a sliding window,
etc.

The enrichment step 106 can also or alternatively comprise an addition to the database of at least one value of an exogenous variable, relating to the environment of the elevator, such as for example, the temperature outside the elevator, the number of floors served by the elevator, etc.

Of course, this enrichment step 106 is also optional.

During step 108, the method generates at least two classifiers, implementing different classification algorithms. In the present example, the method generates three classifiers, namely:
a first classifier carrying out a classification using a decision tree,
a second classifier carrying out a classification using a neural network,
a third classifier carrying out a classification using partitioning, known as data clustering.

In practice, this step 108 creates an instance of each of these classifiers as a function of the number of data input and the number of states output. In the present case, each classifier is instantiated in order to accept 6 variables as input and to carry out a prediction of a breakdown of each elevator, i.e. to carry out a classification in a single class corresponding to a single state, namely “state=breakdown”.

During an optional step 110, it is possible to apply at least one parameter, called constraint parameter, relating to the architecture of a classifier. In the present case, the step 110 sets for the first classifier the value of a maximum depth parameter and for the second classifier the value of a nodes parameter, these values being predetermined by the user or by an operator.

During a step 112, each classifier generated during step 108 is then subjected to training with 60% of the data from the source database, comprising for each state multiple past occurrences of a breakdown of each elevator. In the present example, the machine learning carried out is a supervised learning, i.e. each occurrence of a breakdown is indicated to each classifier as an output, and the values of the variables measured before this breakdown are entered as input data.

An optional step 114 makes it possible to carry out a cross-validation of the machine learning of each classifier, by cross-validation of the training of each classifier, for example over 20% of the data from the database. Of course, this 20% is different from the 60% of data utilized in step 112. This is a simple test step, making it possible to verify the stability of the classifier. If the training is not effective, the classifier will not be stable and will not be chosen for subsequent use.

The prior phase 102 then comprises a step 116 of selecting the classifier, which provides the best prediction result. To this end, each of the three classifiers is tested on the same 20% of the data from the source database. For each of the three classifiers, the following are measured:
a data, called accuracy data, relating to an error rate during the detection of the past occurrences of a breakdown state of each elevator: this accuracy data gives evidence of the errors during the classification, such as for example the fact of failure to detect a past breakdown or detecting a breakdown when none took place; and
a data, called recall data, relating to the number of past breakdowns detected.

Depending on the value of the accuracy data and the value of the recall data for each classifier, the classifier supplying the best detection performance is selected.

During a step 118, the selected classifier, for example the first classifier, is stored as best classifier. The other classifiers are also stored, during this step 120.

Preferentially, training steps 112-116 are carried out taking account of the values of the measured variables, calculated if necessary, in a sliding time window, of a predetermined retrospective value such as a month or 15 days, the end of which corresponds to the current time or to the time of the latest measurement.

The predetermined value of the time window can be predetermined or set during a step, for example carried out at the same time or before step 104 of generating the source database.

Following the prior phase 102, the method 100 comprises at least one iteration of a phase 120, called detection phase.

Phase 120 comprises a step 122 of updating the source database over time. This step 122 adds to the timeline associated with each elevator the latest values of the latest variables measured, if necessary calculated, in association with hourly data indicating the time of the measurement for each new value of each new variable.

Phase 120 also comprises a prediction step 124 with the best classifier as a function of the data from the updated database. To this end, the latest values added to the database, preferentially with the values stored in the database prior to the updating step and located within the sliding time window, are input data for the best classifier, which supplies a prediction data, signalling the presence or absence of a future occurrence of a breakdown state of an elevator.

Prediction step 124 can be carried out after “n” updating steps, with n≥1, or according to another frequency, for example temporal, for example every week, or also on demand by an operator.

When the prediction data forecasts an occurrence of a breakdown, the method according to the invention can comprise one or more steps of an audible or visual alarm sent to a local or remote operator.

The method 100 in FIG. 1 also comprises at least one iteration of a step 126, called verification step, for verifying over time that the best classifier remains that which, from all the classifiers generated and stored in step 118, supplies the best prediction performance. To this end, this step 126 comprises an iteration of steps 112-116 described above, with the database as updated at the time of carrying out the verification step.

This verification step is carried out after “n” iterations of the prediction step or the prediction phase, with n≥1, or according to another frequency, for example temporal, for example every week, or also on demand by an operator. If the best classifier is still that currently in use, then the method 100 resumes at step 122 with the current best classifier. If not, the method resumes at step 122 with the new best classifier, which is stored instead of the old best classifier.

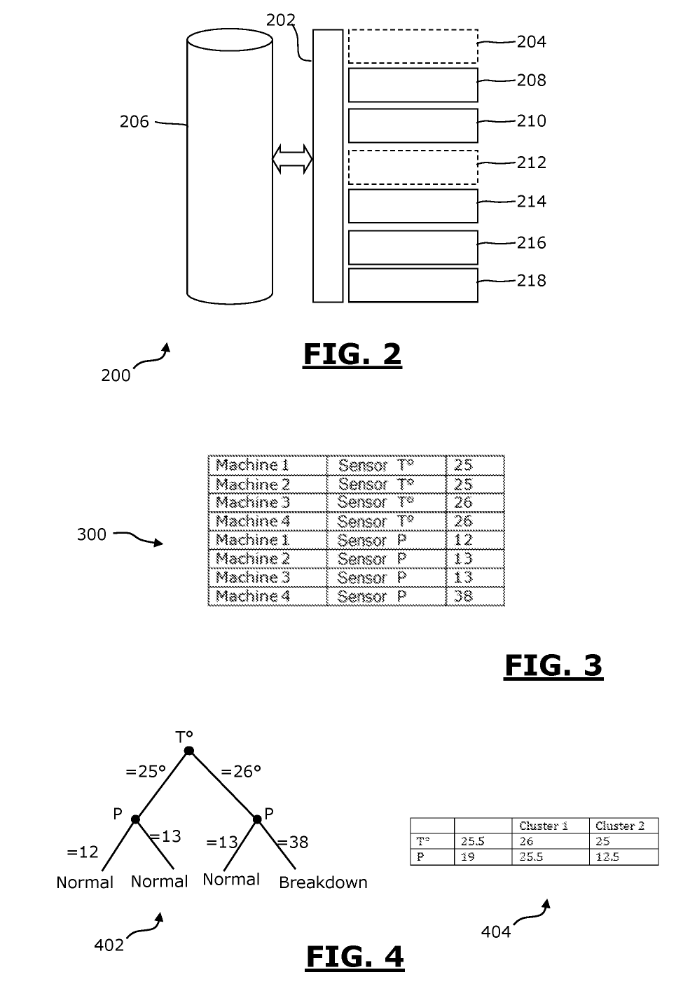

FIG. 2 is a diagrammatic representation of a non-limitative example of a system according to the invention, in particular configured for implementing the method 100 in FIG. 1.

The system 200 in FIG. 2 comprises a supervision module 202 for managing and coordinating the operation of the different modules of the system, namely:
an optional module 204, configured for generating a source database 206, by reconciliation of different existing databases and/or by data enrichment, in particular as described above with reference to steps 104 and 106;
a module 208 for instantiation of several classifiers, configured for creating an instance of several classifiers, and optionally in order to set at least one parameter relating to the architecture of at least one classifier, in particular as described above with reference to steps 108 and 110;
at least one training module 210, configured for carrying out the machine learning of each classifier, in particular as described above with reference to step 112;
at least one optional cross-validation module 212, configured for carrying out a cross-validation of each classifier, in particular as described above with reference to step 114;
at least one selection module 214, configured for selecting the best classifier, in particular as described above with reference to step 116;
at least one updating module 216, configured for updating the source database over time, in particular as described above with reference to step 122;
at least one prediction module 218, configured for supplying a prediction data concerning the future occurrence of a state, for example of a breakdown, in particular as described above with reference to step 124; and
at least one verification module 220, configured for verifying that the best classifier is still that used for the prediction, in particular as described above with reference to step 124.

Although shown separately in FIG. 2, several modules, and in particular all the modules, can be integrated into a single module.

The system 200 can be a computer, a processor, an electronic chip or any other means that can be configured physically or via software for carrying out the steps of the method according to the invention.

FIGS. 3-4 give a diagrammatic representation of a highly simplified example of the method according to the invention in its application to machines.

The example shown in FIGS. 3-4 relates to four machines for which two variables are measured, one corresponding to the temperature T° in the machine and the other to the pressure P in the machine.

The values of the variables are measured and uploaded to a server remote from the machines at least once a day, over a communications network of the Internet type. At each upload, the measured values of the variables are stored in a table, such as the table 300 shown in FIG. 3.

In the table 300, the measured values for the variables T° and P at a given time show that the four machines have different behaviours. Machines 1, 2 and 3 are operating normally, and machine 4 is operating abnormally, which indicates a breakdown.

In the present example, in order to predict the behaviour of each machine in the future, an instance of two different classifiers is created, namely one instance of a classifier of the decision tree type and one instance of a classifier of the kMeans type.

On the basis of numerous measurements of the variables T° and P uploaded in the past for each machine, the past state of operation, normal operation or abnormal operation for each machine, each classifier is subjected to:
a training with a first part, for example 60%, of the uploaded values,
then a cross-validation on a second part, for example 20%, of the uploaded values.

Finally, the two classifiers are tested on a third part, the remaining 20%, of the uploaded values in order to determine the best classifier for predicting the behaviour of each of the four machines.

For reasons of clarity of description, in the present example, each of the two classifiers created is tested on the values indicated in Table 300. The result obtained is shown in FIG. 4 for each classifier. Thus, the classifier of the decision tree type 402 makes it possible to detect the breakdown of machine 4 and the normal operation of the three other machines, while the classifier of the kMeans type 404 detects normal operation for two of the machines and a breakdown for the other two.

As a result, the best classifier from the two classifiers tested is the decision tree type classifier, which is selected and used for the future predictions relating to the operation of these four machines.

The example shown in FIGS. 3-4 is a highly simplified example, given by way of illustration only. In a real case, the number of variables is much larger, of the order of a thousand variables, and the number of machines is also larger. As a result, the size of the classifiers is also larger than the size of the classifiers shown in FIG. 4.

Of course, the invention is not limited to the examples which have just been described and numerous adjustments can be made to these examples without exceeding the scope of the invention.

1. A method for predicting the realization of at least one state that can be adopted by an object, before said state is realized, based on a database, called source database, storing for a least one past occurrence of said at least one state, values of at least one variable relating to said object, determined before said occurrence of said state, said method comprising the following steps:
generating at least two classifiers according to two different data classification algorithms;
for each of said classifiers, machine learning on a first part of said source database; and
selecting, from said classifiers, one classifier, called best classifier, providing the best prediction performance on a second part of said source database, by comparing the results supplied by each classifier;
said method also comprising a phase, called detection phase, comprising:
updating said source database over time, with at least one new value for said variable; and
at least one step of predicting a state of said object by said best classifier, based on said updated source database.

2. The method according to claim 1, characterized in that it also comprises at least one iteration of a step, called verification step, for verifying over time that the best classifier remains that which, from all the classifiers generated, supplies the best prediction performance, said verification step comprising the learning and selection steps carried out on said updated database at the time of said iteration of said verification step.

3. The method according to claim 1, characterized in that the step of selecting the best classifier comprises:
measuring, for each classifier:
a data, called accuracy data, relating to an error rate during detection of the past occurrences of at least one state;
a data, called recall data, relating to the number of past occurrences of at least one state, detected by said classifier;
selecting the best classifier as a function of said accuracy data and/or said recall data.

4. The method according to claim 1, characterized in that it also comprises, after the step of machine learning, a step, called cross-validation step, testing at least one, in particular each, classifier, on a third part of said source database.

5. The method according to claim 1, characterized in that, for at least one classifier, the generating step comprises a step of setting/inputting of a parameter relating to the architecture of said classifier, such as a maximum/minimum number of nodes and/or a maximum/minimum depth of said classifier.

6. The method according to claim 1, characterized in that it comprises, before the machine learning step, a step of generating said source database by reconciliation of at least one database comprising values of at least one variable relating to said object, with at least one other database comprising data relating to at least one past occurrence of at least one state.

7. The method according to claim 1, characterized in that the source database stores:
for each measured value of a variable, at least one time data relating to the time said value was measured, and
for each past occurrence of at least one, in particular each, state, a time data relating to the time of said occurrence.

8. The method according to claim 1, characterized in that at least one, in particular each, of the steps, in particular the learning step, and/or the selecting step, and/or the predicting step, takes account of the data on a predetermined sliding time window preceding the current time.

9. The method according to claim 1, characterized in that the source database comprises:
at least one data calculated as a function of one or more measured data and from a predetermined relationship,
at least one data, called exogenous data, relating to an environment in which said object is located.

10. The method according to claim 1, characterized in that at least one classifier is:
a decision tree,
a support vector machine, or
a clustering algorithm, i.e. a hierarchical or partitioning grouping algorithm.

11. The method according to claim 1, characterized in that for at least one classifier, the machine learning step can carry out training that is:
supervised,
not supervised,
semi-supervised,
partially supervised,
by reinforcement, or
by transfer.

12. The method according to claim 1, characterized in that it is implemented for predicting the realization of at least one state for several objects arranged on one and the same site or on at least two sites distributed in space.

13. The method according to claim 1, characterized in that it is implemented for predicting a breakdown state of a machine or of an element of a machine.

14. A computer program product comprising: instructions implementing all the steps of the method according to claim 1, when it is implemented or loaded into a computer device.

15. A system comprising: means configured for implementing all the steps of the method according to claim 1.
